(19) United States
(12) Patent Application Publication
(10) Pub. No.: US 2006/0006813 A1
(43) Pub. Date: Jan. 12, 2006

(54) Device and method for determining the current flowing through a gas discharge lamp

(75) Inventor: Dolf Henricus Jozef Van Casteren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/526,306

(22) PCT Filed: Aug. 6, 2003
(86) PCT No.: PCT/IB03/03493

§ 371 Date: Mar. 2, 2005

(30) Foreign Application Priority Data
Sep. 6, 2002 (EP) 02078675.2

(51) Int. Cl. H05B 41/16

(52) U.S. Cl. 315/274

(57) ABSTRACT

The present invention relates to a device for operating a gas discharge lamp, comprising a switch-mode power supply circut for supplying power to the discharge lamp, the switch-mode power supply circuit comprising a half- or full-bridge commutating forward converter with at least a rail line for supplying a rail voltage, a first switching element, a second switching element, and an output node between said switching elements for supplying current to the lamp, and comprising a current-determining circuit for providing a signal representative of the converter current, wherein the current-determining circuit comprises a first current sensing circuit for sensing the current in a first position between the rail and the output node and a second current sensing circuit for sensing the current in a second position between the output node and ground. The invention also relates to a method and an electronic ballast for operating a gas discharge lamp.

The present invention relates to a device and method for determining the current flowing through a gas discharge lamp. The present invention also relates to an electronic ballast for operating a gas discharge lamp.

Nowadays power control devices or ballasts are widely used for controlling the power supplied to discharge lamps such as fluorescent lamps. Ballasts may be employed, for example, to optimize the preheating and ignition of the discharge lamp, to maintain a constant power to the electric discharge lamp for the purpose of maintaining a selected light intensity, or for the purpose of controlled dimming to a fixed, but adjustable, power level of the discharge lamp.

Modem electronic ballasts comprise a switch-mode power supply (SMPS) connected between the supply voltage (typically the mains) and the discharge lamp. In a three-stage ballast circuit, the first stage of the switch-mode power supply comprises a preconditioner, for example a double rectifier for rectifying the mains (230 V, 50 Hz, 1 phase), combined with an up-converter. The second stage may comprise a down-converter (DC-DC converter), also called a forward or buck converter, for stabilizing the output current. The third stage of the ballast circuit comprises a commutator bridge and ignitor to implement a square wave current operation of the lamp. In a two-stage ballast topology, the down-converter and commutator bridge are replaced by a half-bridge commutating forward (HBCF) or a full-bridge commutating forward (FBCF) topology.

The half-bridge commutating forward (HBCF) circuit corresponds to a full-bridge commutating forward (FBCF) circuit wherein part of the bridge is replaced by two (electrolytic) bridge capacitors in series. The ballast in this topology comprises an up-converter in combination with a half bridge acting as a double down-converter. This two-stage ballast topology for operating a HID lamp is relatively simple and relatively inexpensive.

The control of the power supplied to the lamp may be based on the outcome of measurements of various lamp parameters, such as the actual current flowing through the commutating forward coil element (HBCF-coil of FBCF-coil). This converter current may be used as a measure of the actual current flowing through the lamp. Measurement of the HBCF/FBCF coil current or converter current may be implemented in various ways, each of them having a number of drawbacks.

One of the methods of determining the converter current is to provide a current shunt, for example by connecting a sensing resistor in series with the HBCF coil. The differential voltage across the sense resistor is measured by means of a differential amplifier. The current flowing through the sensing resistor and consequently the actual converter current, i.e. the current flowing through the HBCF coil, can be determined from the known resistance value of the sensing resistor. However, one of the disadvantages of this method is that a high-specification operational amplifier, that is an operational amplifier with a large common mode rejection ratio, is needed, resulting in a considerable cost of the ballast. Furthermore, the signals measured with the amplifier have relatively small values, because the resistance value of the sensing resistor should be as small as possible to minimize the losses induced by the insertion of the sensing resistor. These small values lead to a poor signal to noise ratio.

A further method of determining the converter current is to use a current transformer, for example by connecting the primary windings of a current transformer in series with the HBCF coil. The secondary windings of the transformer will then provide a signal proportional to the converter current. However, one of the disadvantages of this method is that not only the high-frequency components of the current signal, but also the low-frequency components of the current signal are to be transferred. To guarantee the transfer of the low-frequency components, i.e. the low-frequency commutation signal, of the current signal, a relatively bulky transformer is needed.

Furthermore, asymmetrical current operation of the discharge lamp cannot be detected. During the start phase and/or at the end of life (EOL) of the lamp, the lamp behavior may be irregular, causing an asymmetrical lamp load of the above-mentioned commutating forward circuit. The lamp, for example, may be conducting in one half period of the duty cycle of the switch-mode power supply and may be non-conducting in the other half period. The resulting DC component cannot be determined in the above-mentioned full-bridge commutating forward circuit. In the above mentioned half-bridge commutating forward circuit, the asymmetrical load of the half bridge results in a displacement of the midpoint voltage in the bridge capacitor series circuit, i.e. the voltage that is the voltage at the junction between the first and second bridge capacitors is increased or decreased. As a result of this voltage drift, the maximum voltage rating of one of the bridge capacitors may be exceeded, causing damage to the ballast.

It is an object of the invention to provide a device and method for determining the converter current and to provide an electronic ballast wherein the above-mentioned drawbacks are obviated.

According to a first aspect of the invention, this object is achieved in a device for determining the current supplied to a discharge lamp by a commutating forward converter, which converter can be connected to a rail line for supplying a rail voltage and comprises a first switching element, a second switching element, and an output node between said switching elements for supplying said current to the discharge lamp, the device comprising a first current sensing circuit for sensing the current in a first position between the rail and the output node and a second current sensing circuit for sensing the current in a second position between the output node and ground. By sensing the currents in two positions, in a position in the upper half of the bridge and in a position in the lower half of the bridge, only the high-frequency component of the current signal (typically in the range of 30 kHz-250 kHz) is to be determined. Sensing of the low-frequency components, such as the commutation frequency, typically in the range of 50-400 Hz, can be dispensed with. This allows the use of relatively small current transformers, the total volume of which is less than that of the single current transformer method discussed above. Furthermore, for half-bridge applications asymmetrical operation can be detected. This enables control circuitry of the power supply to adapt the duty cycle of the switching elements so as to correct the midpoint voltage and hence the voltages across the bridge capacitors to safe values. A DC component can be detected also for full bridge applications.

Furthermore, the power losses with this measurement method are reduced as compared with the losses arising in the current shunt method discussed above. Also the output signals need no further amplification, which avoids noise or interference problems.

In a preferred embodiment, the first sensing circuit comprises a first current transformer having a primary winding connected to said first position and the second sensing circuit comprises a second current transformer having a primary winding connected to said second position, the secondary windings of the first and second current transformers being connected in series for providing a combined signal representative of the converter current.

According to another aspect of the present invention, an electronic ballast is provided for operating a gas discharge lamp, comprising:

a switch-mode power supply (SMPS) circuit for supplying power to the discharge lamp, the switch-mode power supply circuit comprising a half- or full-bridge commutating forward converter with at least a rail line for supplying a rail voltage, a first switching element, a second switching element, and an output node between said switching elements for supplying current to the lamp; and

a current-determining circuit for providing a signal representative of the converter current;

wherein the current-determining circuit comprises a first current sensing circuit for sensing the current in a first position between the rail and the output node and a second current sensing circuit for sensing the current in a second position between the output node and ground.

In a preferred embodiment, the ballast comprises a gate driving circuit connected to the gates of the first switching element and the second switching element and to the current determining circuit for controlling the switching of the switching elements on the basis of said signal representative of the converter current. The signal representative of the converter current is fed back to the control circuitry that controls the duty cycle of the switching elements of the switch-mode power supply. The duty cycle of the switching elements may be adapted by the control circuitry on the basis of this signal.

According to still another aspect of the present invention, a method is provided of determining the current supplied by a commutating forward converter to a gas discharge lamp, the converter comprising at least a rail line for supplying a rail voltage, a first switching element, a second switching element, and an output node between said switching elements for supplying current to the lamp, the method comprising the steps of:

sensing the current in the converter in a first position between the rail line and the output node and providing a first output signal;

sensing the current in the converter in a second position between the output node and ground and providing a second output signal;

adding the first and second output signals so as to provide a third output signal representative of the converter current.

If the first signal is the current measured in the first position, the second signal is the current measured in the second position, and the third signal is the sum of the current measured in the first position and the simultaneously measured current in the second position, a measure is obtained of the current flowing through the HBCF coil. This current is a measure of the current flowing through the lamp.

Further advantages, features and details of the present invention will be elucidated with reference to the annexed drawings, in which:

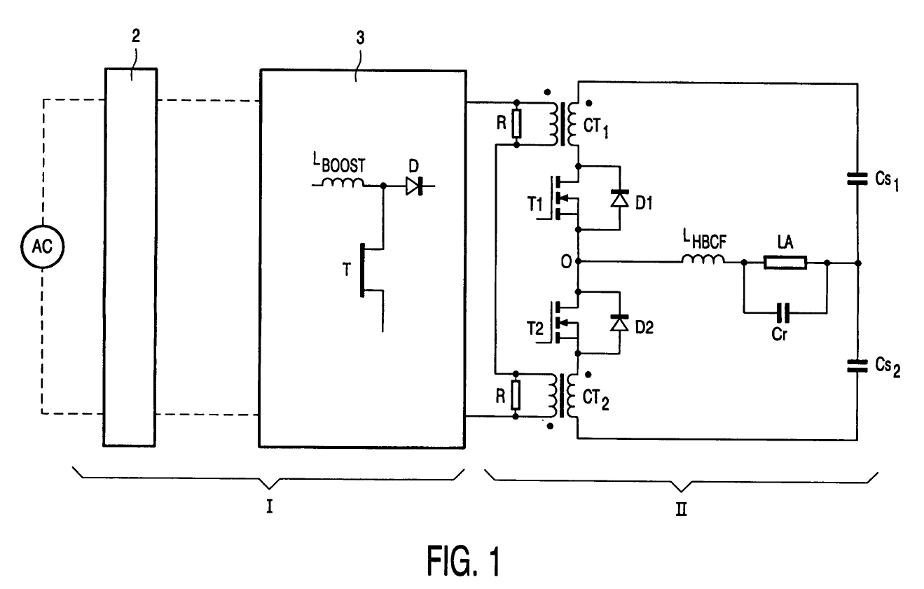

FIG. 1 shows a schematic circuit diagram of an electronic ballast according to a first preferred embodiment of the present invention;

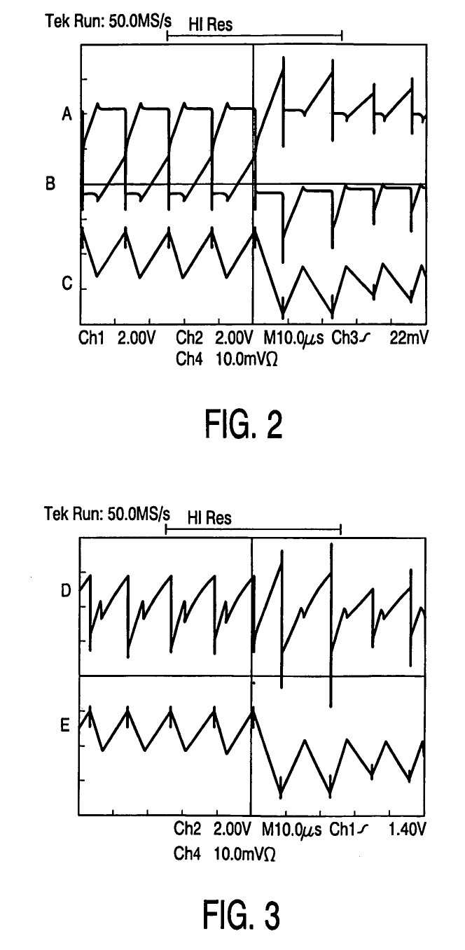

FIG. 2 shows a graph of the current signal of the upper switching element, the current signal of the lower switching element, and the converter current;

FIG. 3 shows a graph of the combined current signals of the upper and lower switching elements and the converter current; and

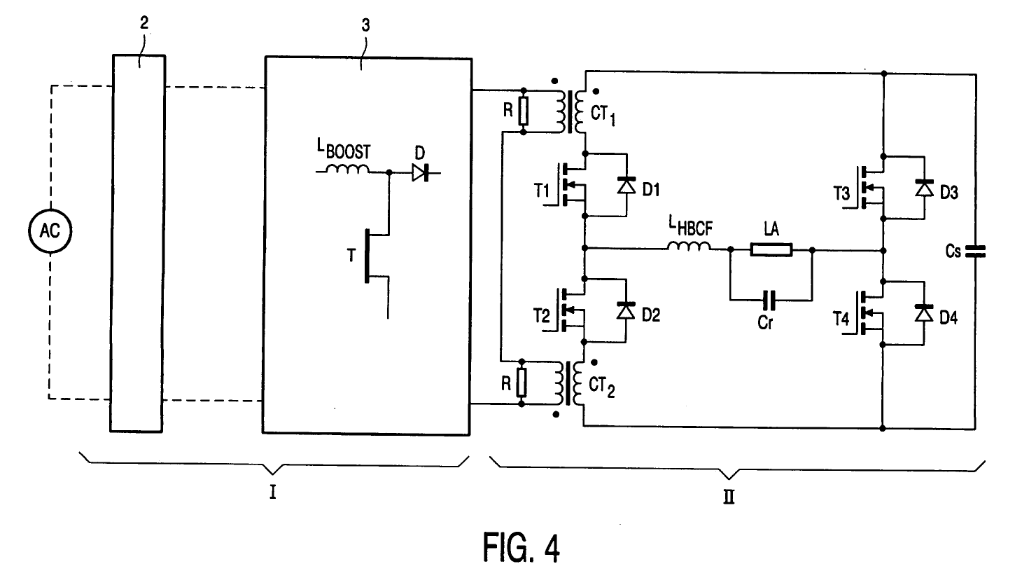

FIG. 4 is a schematic circuit diagram of an electronic ballast according to a second preferred embodiment of the present invention.

FIG. 1 shows a two-stage ballast for a high-intensity discharge lamp (LA). The first stage (I) of the ballast comprises a rectifier 2 for converting the AC supply voltage (typically a 230 V 50 Hz mains) to a DC supply voltage and an up-converter or boost converter 3 for boosting the DC supply voltage. FIG. 1 shows a typical topology of a boost converter or up-converter. The boost converter inter alia is composed of an inductor (Lboost), a switching element (T) and a diode (D).

The second stage (II) of the ballast as shown in FIG. 1 comprises a half-bridge commutating forward (HBCF) circuit acting as a double down-converter. The HBCF circuit comprises a first MOSFET T1, a second MOSFET T2, a first and a second (internal) body diode D1 and D2, an inductor Lhbcf in series with the lamp, a lamp capacitor Cr connected parallel to the lamp, and two electrolytic bridge capacitors Cs1 and Cs2 connected in series. The half-bridge commutating forward circuit is operated in the critical discontinuous mode to allow zero-voltage switching. Each half commutation period (commutation frequency of the order of 100 Hz), one MOSFET (the first MOSFET T1 or the second MOSFET T2) is operated in combination with the diode (D2 or D1) of the other MOSFET. Switching of the MOSFETS is accomplished by a duty cycle control circuit, as is schematically shown in FIG. 1. This circuit controls the duty cycle of the half-bridge commutating forward circuit. The control may be made dependent on the converter current or at least on a signal representative of the converter current, as determined according to the invention.

The primary windings of a first current transformer CT1 are connected between the rail line and the first MOSFET T1. The current transformer may equally well be connected between the MOSFET T1 and the output node (O) between the two MOSFETS T1 and T2. The primary windings of a second current transformer CT2 are connected between the second MOSFET T2 and ground or between the output node (O) and the second MOSFET T2. The secondary windings of the first transformer and second transformer are connected in series.

FIGS. 2 and 3 show measurements of the current flowing through the core of first transformer CT1 in the upper part of the half-bridge commutating forward circuit and the current flowing through the core of the second transformer CT2 in the lower part of the half-bridge commutating forward circuit. FIG. 2 in fact shows three signals. Signal A represents the response in time of the first current transformer CT1 belonging to the upper MOSFET (T1), while signal B is the response in time of the current transformer CT2 belonging to the lower MOSFET (T2). Signal C shows the actual converter current as a function of time. The left part of the Figure shows a first commutation half period, while the right part of the Figure shows a subsequent half commutation period.

It is apparent from FIG. 2 that only the high-frequency components of the currents through the transformer cores are transferred well, whereas the low-frequency (commutation) frequency components fade out quickly. In FIG. 3, signal D is a signal that is equal to signal A added to signal B. It becomes clear that the effects of the weak low-frequency response and the mean values are cancelled. The resulting current signal D gives clear zero and peak current information. This information can be used to assess the operation of the converter current and consequently the lamp current. The resulting current signal as a consequence may be used to be sure of a more pure AC lamp operation.

Although the low-frequency part of the current signal fades out quickly, the relatively small current transformers still show a small transfer of the low-frequency part of the current signal, as can be derived from signals A and B in FIG. 2. Especially signal B clearly shows that after commutation the zero level slowly approaches the “zero axis”. The low-frequency part of the signal has disappeared already after a few high frequency periods. The above-mentioned series connection of the secondary windings of the current transformers, resulting in signal D in FIG. 3, has the following advantages.

The slight low-frequency transfers of both transformers will cancel each other out and will not influence the output signal (C). This implies that the low-frequency transfer performance of the transformers has become less relevant. To improve the above-mentioned cancellation of the low-frequency components of signals A and B, the transformers are chosen such that the low-frequency responses of the two transformers are substantially identical.

A further advantage is that the resulting signal D (FIG. 3) is unipolar or rectified. Regardless of the direction (positive or negative) in which the commutating forward converter sends the current (cf. FIG. 3, signal E), the maximum value of the current will be positive. Consequently, the peak current detection circuit, which is connected to the secondary side of the current transformers, needs only to detect the positive maximum. Also in the case of a zero-crossing, the flank will always change from a negative flank through zero to a positive flank.

FIG. 4 shows a two-stage ballast for a high-intensity discharge lamp (LA), of which the first stage (I) corresponds to the ballast shown in FIG. 1. The second stage (II) of the ballast shows a full-bridge commutating forward (FBCF) topology. The FBCF circuit comprises a first MOSFET T1, a second MOSFET T2, a third MOSFET T3, and a fourth MOSFET T4, first, second, third, and fourth (internal) body diodes D1-D4, a lamp inductor Lhbcf in series with the lamp, a lamp capacitor Cr connected parallel to the lamp, and one electrolytic capacitor Cs parallel to the second and third MOSFET. The full-bridge commutating forward circuit is operated in the critical discontinuous mode to allow zero-voltage switching. Similar to the ballast shown in FIG. 1, the primary windings of a first current transformer CT1 are connected between the rail line and the first MOSFET T1. The primary windings of a second current transformer CT2 are connected between the second MOSFET T2 and ground or between the output node (O) and the second MOSFET T2. The secondary windings of the first transformer and second transformer are connected in series. The combination of the signal derived from the first transformer and the signal derived from the second transformer will give a signal representative of the converter current.

Since the actual peak current through the MOSFET is measured by means of the above-mentioned current transformers during each high-frequency period, the current is always the same, both in the positive and in the negative cycle part of the low-frequency current. A DC component (amplitude difference between the positive and negative low-frequency cycle part) therefore is not possible.

The present invention is not limited to the preferred embodiments thereof described above; the rights sought are defined by the following claims, within the scope of which many modifications can be envisaged.

1. Electronic ballast for operating a gas discharge lamp, comprising:
a switch-mode power supply (SMPS) circuit for supplying power to the discharge lamp, said switch-mode power supply circuit comprising a half- or full-bridge commutating forward converter with at least a rail line for supplying a rail voltage, a first switching element (Q1), a second switching element (Q2), and an output node between said switching elements for supplying current to the lamp;
a current-determining circuit for providing a signal representative of the converter current;
wherein the current-determining circuit comprises a first current sensing circuit for sensing the current in a first position between the rail and the output node and a second current sensing circuit for sensing the current in a second position between the output node and ground.

2. Electronic ballast according to claim 1, wherein the first sensing circuit comprises a first current transformer having a primary winding connected to said first position and the second sensing circuit comprises a second current transformer having a primary winding connected to said second position, the secondary windings of the first and second current transformers being connected in series for providing a combined signal representative of the converter current.

3. Electronic ballast according to claim 1 or 2, comprising a gate driving circuit connected to the gates of the first switching element and the second switching element and to the current-determining circuit for controlling the switching of the switching elements on the basis of said signal representative of the converter current.

4. Device for determining the current supplied by a commutating forward converter to a discharge lamp, which converter can be connected to a rail line for supplying a rail voltage and comprises a first switching element, a second switching element, and an output node between said switching elements for supplying said current to the discharge lamp, the device comprising a first current sensing circuit for sensing the current in a first position between the rail and the output node and a second current sensing circuit for sensing the current in a second position between the output node and ground.

5. Device according to claim 4, wherein the first sensing circuit comprises a first current transformer having a primary winding connected to said first position and the second sense circuit comprises a second current transformer having a primary winding connected to said second position, the secondary windings of the first and second current transformers being connected in series for providing a combined signal representative of the converter current.

6. Method of determining the current supplied by a commutating forward converter to a gas discharge lamp, the converter including at least a rail line for supplying a rail voltage, a first switching element, a second switching element, and an output node between said switching elements for supplying current to the lamp, the method comprising the steps of:
sensing the current in the converter in a first position between the rail line and the output node and providing a first output signal;
sensing the current in the converter in a second position between the output node and ground and providing a second output signal;
adding the first and second output signals so as to provide a third output signal representative of the converter current.

7. Method according to claim 6, wherein the first signal is the current measured in the first position, the second signal is the current measured in the second position, and the third signal is the sum of the current measured in the first position and the simultaneously measured current in the second position.

8. Method according to any of claims 6 or 7, wherein the electronic ballast according to any of claims 1-3 and/or the device according to any of claims 4-5 is applied.
